(19) United States
(12) Patent Application Publication
(10) Pub. No.: US 2007/0086154 A1
(43) Pub. Date: Apr. 19, 2007

(54) Auxiliary display system

(76) Inventor: William F. Koch, Madison, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/582,114

(22) Filed: Oct. 16, 2006

Related U.S. Application Data
(60) Provisional application No. 60/727,531, filed on Oct. 17, 2005.

(51) Int. Cl. G06F 1/16

(52) U.S. Cl. 361/681; 361/683; 248/917

(57) ABSTRACT

An auxiliary display system for use with a laptop computer having a screen portion and a base portion. The system includes a housing having a partially-enclosed cavity, a flat panel display retractably and pivotally attached to the housing so that the flat panel display may be pivotally adjusted when extended from the cavity and in use and retracted to a position within the cavity when not in use. The system also includes a bracket joined with a top edge or side edge of the housing for releasably joining the housing to the screen portion of the laptop computer and support legs pivotally joined with a bottom edge of the housing for releasably joining the housing to the base portion of the laptop computer. The support legs are configured to substantially support the auxiliary display system.

### CROSS REFERENCE TO RELATED APPLICATION(S)

This application claims the benefit of U.S. Provisional Application No. 60/727,531, filed Oct. 17, 2005, which is incorporated by reference as if disclosed herein in its entirety.

### BACKGROUND OF THE INVENTION

(1) Field of the Invention

The present invention generally relates to a flat panel display for a computer system. In particular, the present invention is directed to an auxiliary display system including a flat panel display for use with a laptop computer.

(2) Description of the Related Art

The popularity in laptop computers continues to grow because of cheaper costs and the ability to have a powerful computer in a mobile lightweight form. Many people work on two or more additional monitors on desktop computers and laptops can accommodate an additional monitor with the given standard video card. This is done to give more workspace to the user so that they have a larger desktop to use for multiple applications. The additional space that extra monitors provide allow a larger display of information for the user so work can be done faster and more efficiently. When extra desktop space is available, the user does not have to switch back and forth between multiple applications that are being used.

Although laptop users can use an additional monitor to gain extra workspace, it is only limited to the location in which the additional monitor is located. The main reason for buying a laptop computer is to be mobile and to be able to use it whenever and where ever. There are many cases that additional workspace is needed for laptop users when a monitor is not present. Users are forced to use one screen when they are not near an additional monitor.

There have been attempts to integrate two displays in a laptop, but not in a practicable way. In one attempt, a double screen laptop was developed that uses two flat panel displays such as liquid crystal displays (LCDs). The first LCD is in the standard laptop location and the second LCD is folded behind the first LCD when not in use. When the second LCD is in use, it is folded upwards and stands above the location of the standard laptop LCD. The use of this double screen laptop is to give other people the ability to see what is being done on the laptop. By having the second LCD stacked above the standard LCD, the same image is displayed on both LCD so there is a larger display for an audience to see what is being done.

In another attempt, a casing including a laterally extending flat panel display is attached to the screen portion of a laptop. The entire weight of the casing and enclosed flat panel display is supported by the hinges that secure the screen portion of the laptop to the base portion of the laptop.

### BRIEF SUMMARY OF THE INVENTION

One aspect of the present invention is an auxiliary display system for use with a laptop computer having a screen portion and a base portion. The system includes a housing having a partially-enclosed cavity, a flat panel display retractably and pivotally attached to the housing so that the flat panel display may be pivotally adjusted when extended from the cavity and in use and retracted to a position within the cavity when not in use, a mechanism for electrically connecting the flat panel display to the laptop computer, the mechanism being positioned within or on the housing, at least one of an internal rechargeable power source for providing internal power to the flat panel display or a power jack for providing external power to the flat panel display, the at least one being positioned within or on the housing, a bracket joined with a top edge or side edge of the housing for releasably joining the housing to the screen portion of the laptop computer, and support legs pivotally joined with a bottom edge of the housing for releasably joining the housing to the base portion of the laptop computer. The support legs are configured to substantially support the auxiliary display system.

Another aspect of the invention is an auxiliary display system for use with a laptop computer having a screen portion and a base portion. The system includes a housing having a partially-enclosed cavity, a flat panel display retractably and pivotally attached to the housing so that the flat panel display may be pivotally adjusted when extended from the cavity and in use and retracted to a position within the cavity when not in use, a mechanism for electrically connecting the flat panel display to the laptop computer, the means being positioned within or on the housing, at least one of an internal rechargeable power source for providing internal power to the flat panel display or a power jack for providing external power to the flat panel display, the at least one being positioned within or on the housing, a mechanism for releasably joining the housing to the screen portion of the laptop computer, and a mechanism for substantially supporting the auxiliary display system. The mechanism for supporting includes a mechanism for releasably joining the housing to the base portion of the laptop computer.

Still another aspect of the invention is an auxiliary display system for use with a laptop computer having a screen portion and a base portion. The system includes a housing having a partially-enclosed cavity, a flat panel display retractably and pivotally attached to the housing so that the flat panel display may be pivotally adjusted when extended from the cavity and in use and retracted to a position within the cavity when not in use, at least one of a VGA input, a DVI input, a USB input, and a power jack for electrically connecting the flat panel display to the laptop computer, the at least one being positioned within or on the housing, and support legs pivotally joined with a bottom edge of the housing for releasably joining the housing to the base portion of the laptop computer. The support legs are configured to substantially support the auxiliary display system.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a back isometric view of an auxiliary display system according to one embodiment of the present invention;

FIG. 2 is a back isometric view of an auxiliary display system with its cover removed according to one embodiment of the present invention;

FIG. 3 is a front view of an auxiliary display system with its flat panel display extended according to one embodiment of the present invention;

FIG. 4 is a front view of an auxiliary display system with its flat panel display retracted according to one embodiment of the present invention;

FIG. 5 is a top view of an auxiliary display system with its flat panel display extended according to one embodiment of the present invention;

FIG. 6 is an enlarged section view of a clamp mechanism of an auxiliary display system according to one embodiment of the present invention; and

FIG. 7 is an enlarged section view of a clamp mechanism of an auxiliary display system according to one embodiment of the present invention.

### DETAILED DESCRIPTION

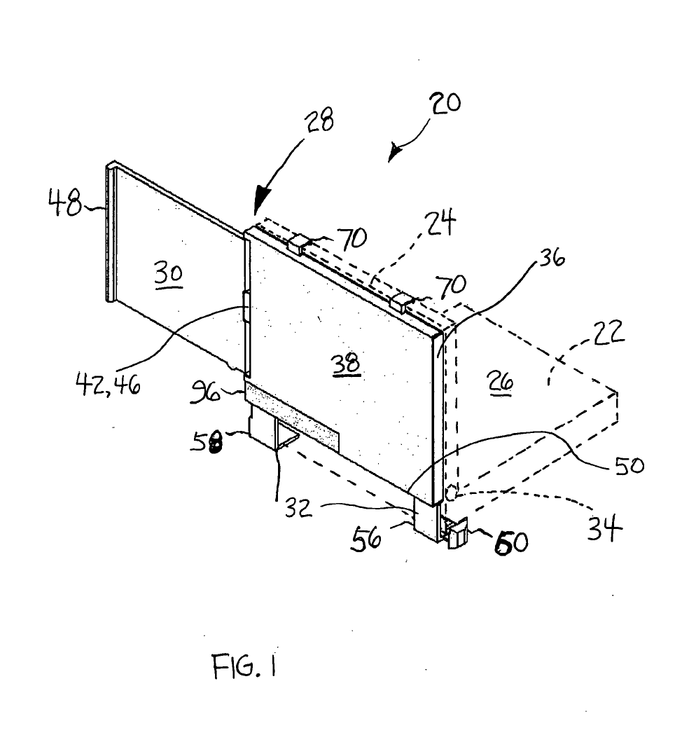

Referring now to the drawings in which like reference numerals indicate like parts, and in particular, to FIGS. 1-5, one aspect of the present invention is an auxiliary display system 20 for use with a laptop computer 22 having a screen portion 24 and a base portion 26. In one embodiment, a housing 28 containing an extendable flat panel display 30 is removably secured to laptop computer 22 thereby providing a second screen to a user of the computer. Housing 28 and flat panel display 30 are supported by support legs 32 rather than by hinges 34 of laptop computer 22.

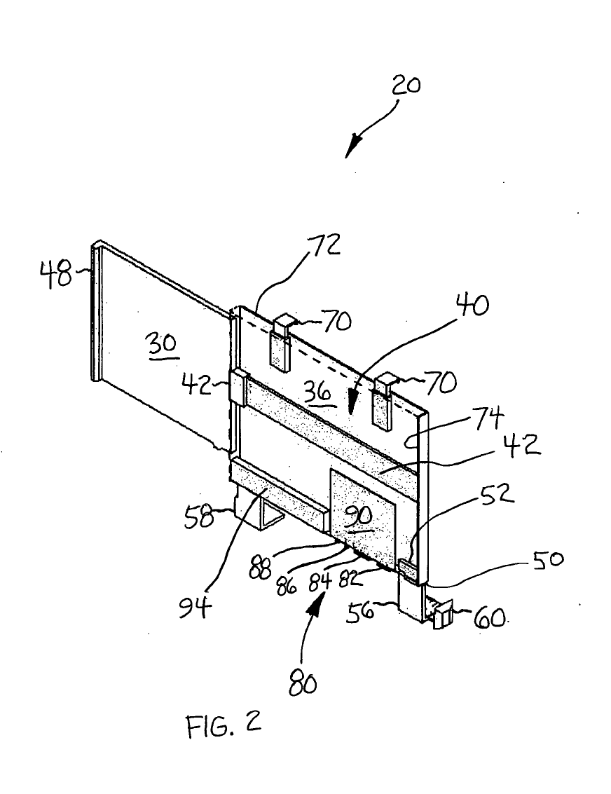

Housing 28 includes a jacket portion 36 and a cover portion 38, which join to form a partially enclosed cavity 40. Jacket portion 36 and cover portion 38 are sized so that cavity 40 is large enough to accommodate various sizes of laptop computer 22. As best illustrated in FIG. 2, a track 42, which is configured to operably engage a sliding mechanism 44, may be positioned within cavity 40 and typically joined with jacket portion 36.

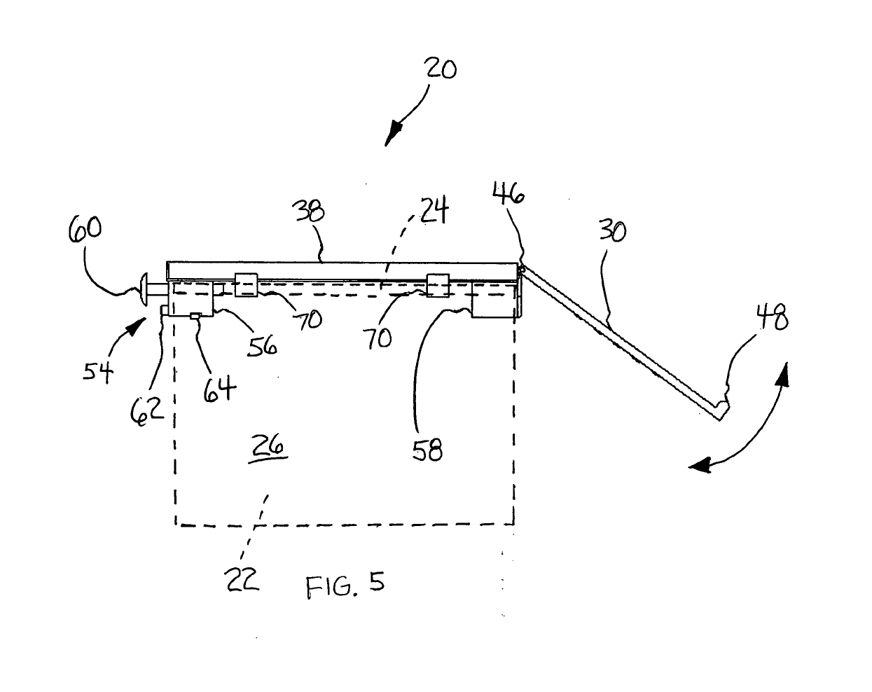

Flat panel display 30 is generally retractably and pivotally attached to housing 28 via a hinge 46 and sliding mechanism 44, which are joined to one another. Sliding mechanism 44 generally slides along track 42 to allow flat panel display 30 to be extended from housing 28 when in use and retracted to a position within the housing when not in use. As indicated by the arrow in FIG. 5, hinge 46 allows flat panel display 30 to be angularly adjusted when extended from housing 28 and in use. Flat panel display 30 may include a handle portion 48 or some other raised surface to more easily allow a user to grasp the display when extending it from cavity 40 and retracting it into the cavity

Support legs 32 are pivotally joined with a bottom edge 50 of housing 28 via a hinge connection 52 to allow the housing to be rotated into an upright position when screen portion 24 is also upright and rotated to a closed position when the screen portion is closed. Support legs 32 are configured to substantially support the weight of auxiliary display system 20. Support legs 32 are generally adjustable and extendable to allow hinge connection 52 to be positioned with respect to hinges 34 so that housing 28 may be folded downwardly over screen portion 24 when the screen portion is closed.

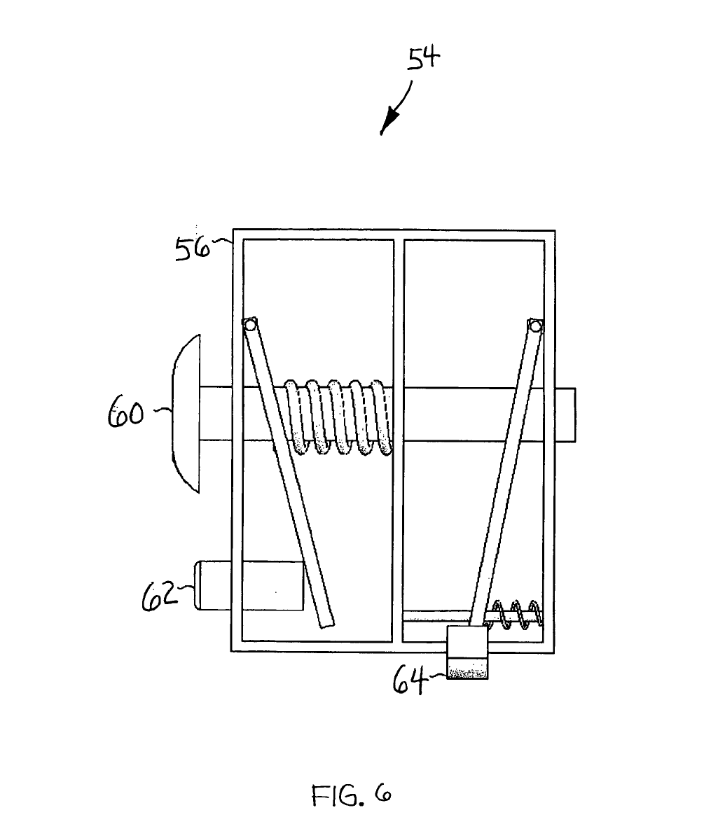

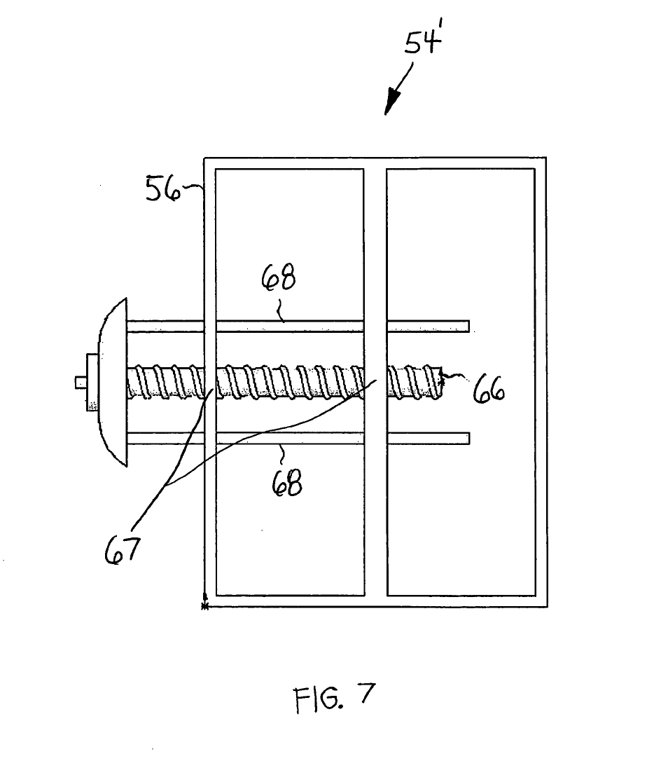

As best illustrated in FIG. 5, at least one of support legs 32 generally includes a mechanism 54 for releasably joining housing 28 to base portion 26 of laptop computer 22. Typically, mechanism 54 is a pressure-fit mechanism for pressure fitting base portion 26 of laptop computer 22 between a first one 56 of support legs 32 and a second one 58 of the support legs. Referring now to FIG. 6, in one embodiment, mechanism 54 is a clamp mechanism having a spring-loaded extendable clamp 60, a clamp-tightening button 62 operably joined with the spring-loaded extendable clamp for tightening the clamp, and a release button 64 operably joined with spring-loaded extendable clamp for loosening the clamp. Referring now to FIG. 7, in another embodiment, a mechanism 54′ is a clamp mechanism having a threaded rod 66, a threaded female portion 67 for receiving the threaded rod, and support rods 68 for supporting the threaded rod as it is screwed into the threaded female portion.

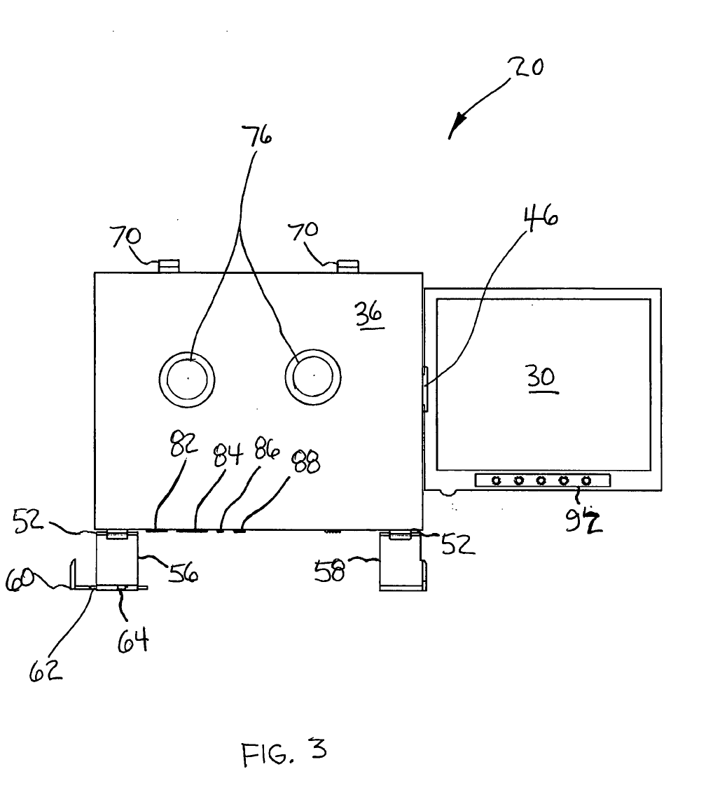

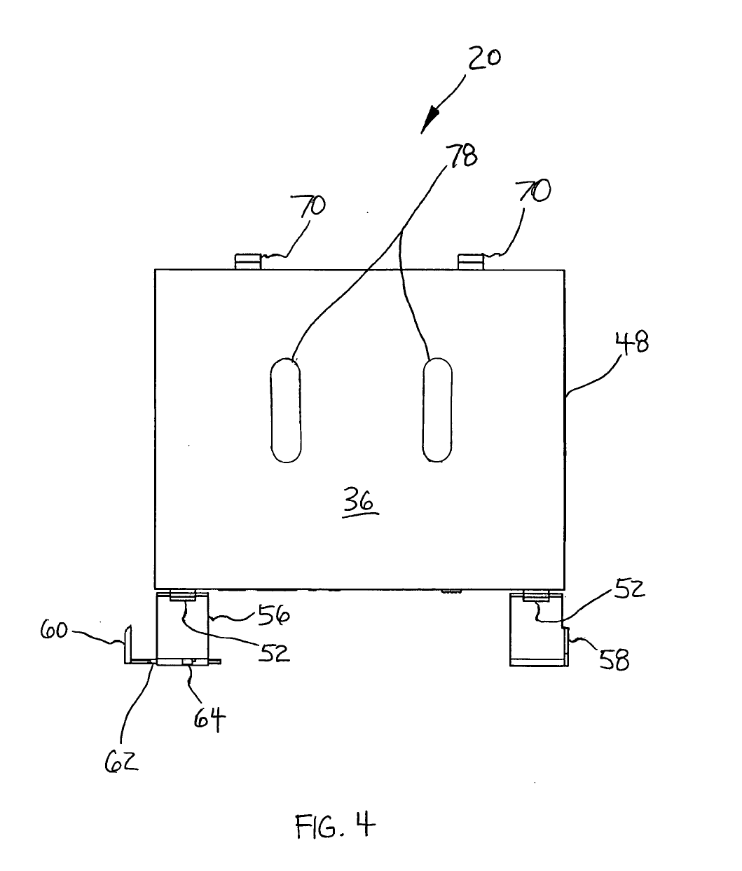

Referring again to FIGS. 1 and 2, housing 28 of auxiliary display system 20 typically include one or more brackets 70 joined with a top edge 72 or a side edge 74 of the housing for releasably joining the housing to screen portion 24 of laptop computer 22. Each of brackets 70 is generally adjustable and extendable to accommodate for different sized screen portions 24 of various laptop computers 22. Referring now to FIGS. 3 and 4, in alternative embodiments, other mechanisms may be used to releasably join housing 28 to screen portion 24. For example, one or more suction cups 76 joined to jacket portion 36 may be used or adhesive strips 78 such as double-sided tape may be used. Of course, it is contemplated within the invention, that myriad ways to releasably join housing 28 to screen portion 24 exist, providing they do not adversely impact the screen portion 24 of laptop computer 22.

Referring again to FIG. 2, auxiliary display system 20 includes one or more electrical connections 80 positioned within or on housing 28 for electrically connecting flat panel display 30 to laptop computer 22 and/or an external power source. Typically, electrical connections 80 include display inputs such as a VGA input 82, a DVI input 84, and a USB input 86, and a power input, i.e., power jack 88. A printed circuit board 90 typically contains both the display inputs and the power input.

Depending on the type of display adapter in both laptop computer 22 and flat panel display 30, the display inputs may be joined with the laptop computer via display adapters positioned within housing 28, which ultimately provide video to be displayed on the flat panel display. For example, a LCD flat panel display typically includes a VGA display adapter, which may be integral to the display or housed separately in housing 28, which translates the VGA signal from laptop computer 22 to display the image on the LCD flat panel display. The display adapter generally also implements actions from a video controller 92 such as a LCD controller in the case of a LCD flat panel display. The LCD controller gives additional control over an LCD such as brightness, horizontal, and vertical positioning, etc. The LCD controller also allows for an external power button so the LCD can be powered off even in a retracted position. If laptop computer 22 also includes a VGA display adapter, no intermediate adapter is required. However, if laptop computer 22 includes a DVI display adapter or USB display adapter, than a DVI to VGA display adapter or USB to VGA display adapter, respectively, will be required to translate the video signals from the laptop to the VGA adapter of flat panel display 30.

Auxiliary display system 20 typically includes both an internal rechargeable power source, e.g., a rechargeable battery 94, for providing internal power to flat panel display 30, and power jack 88 for providing external power to the flat panel display. Rechargeable battery 94 is typically positioned within a battery compartment 96 formed in housing 28 and power jack 88 is typically positioned along bottom edge 50 of the housing between support legs 32. Rechargeable battery 94 may be a standard LCD rechargeable battery that operates at 12 volts and is capable of supplying 3.5 amps for a display adapter such as a VGA display adapter. For LCD displays, the display adapter typically breaks down power supplied from rechargeable batter 94 to power an inverter for a LCD backlight. A battery safety controller is typically positioned within cavity 40 of housing 28 to control the charging of rechargeable battery 94. The safety controller also regulates external power to be delivered to the display adapter of flat panel display 30. The power supplied from the inverter and the display inputs are generally fed to flat panel display 30 through ribbon wires. Ribbon wires allow for flexible movement as flat panel display 30 moves along track 42.

The auxiliary display system of the present invention offers advantages over the prior art. It allows laptop users to gain extra workspace in a mobile way so they always have an extra screen with them. The auxiliary display system is adjustable and may be used on various laptops as an upgrade.

The auxiliary display system attaches to the base portion of a laptop computer. The independent support leg design allows the auxiliary display system to remain semi-independent of the laptop. The auxiliary display system does not have to rely on the support of the laptop hinges in fear of the auxiliary display system being to heavy and causing damage to the laptop.

The holding apparatus is also adjustable so its modular design can accommodate multiple size laptops and apply a tight fit to the base of the laptop. The jacket contains a track that a sliding mechanism can move horizontally along. The flat panel display is attached to the sliding mechanism by hinges so the user can adjust the display forward if necessary. The user can then retract an additional flat panel display whenever needed.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. An auxiliary display system for use with a laptop computer having a screen portion and a base portion, comprising:
a housing having a partially-enclosed cavity;
a flat panel display retractably and pivotally attached to said housing so that said flat panel display may be pivotally adjusted when extended from said cavity and in use and retracted to a position within said cavity when not in use;
means for electrically connecting said flat panel display to the laptop computer, said means being positioned within or on said housing;
at least one of an internal rechargeable power source for providing internal power to said flat panel display or a power jack for providing external power to said flat panel display, said at least one being positioned within or on said housing;
a bracket joined with a top edge or side edge of said housing for releasably joining said housing to the screen portion of the laptop computer; and
support legs pivotally joined with a bottom edge of said housing for releasably joining said housing to the base portion of the laptop computer, wherein said support legs are configured to substantially support said auxiliary display system.

2. An auxiliary display system according to claim 1, wherein said flat panel display includes a handle portion.

3. An auxiliary display system according to claim 1, wherein said housing includes a jacket portion and a cover portion, said jacket and cover portions being joined together to form said cavity.

4. An auxiliary display system according to claim 1, wherein said bracket is adjustable and extendable.

5. An auxiliary display system according to claim 1, wherein said support legs are adjustable and extendable.

6. An auxiliary display system according to claim 1, further comprising a sliding mechanism joined with said flat panel display via a hinge.

7. An auxiliary display system according to claim 6, further comprising a track, which is configured to operably engage said sliding mechanism, positioned within said cavity and joined with said housing.

8. An auxiliary display system according to claim 1, wherein said means for electrically connecting said flat panel display to the laptop computer include a printed circuit board and at least one of a VGA input, a DVI input, a USB input, and a power jack.

9. An auxiliary display system according to claim 1, wherein said internal rechargeable power source is a rechargeable battery positioned within a battery compartment formed in said housing.

10. An auxiliary display system according to claim 1, wherein said support legs include means for releasably joining said housing to the base portion of the laptop computer.

11. An auxiliary display system according to claim 10, wherein said means for releasably joining include a clamp mechanism having a spring-loaded extendable clamp, a clamp-tightening button operably joined with said clamp for tightening said clamp, and a release button operably joined with said clamp for loosening said clamp.

12. An auxiliary display system according to claim 10, wherein said means for releasably joining include a clamp mechanism having a threaded rod, a threaded female portion for receiving said threaded rod, and support rods for supporting said threaded rod as it is screwed into said threaded female portion.

13. An auxiliary display system for use with a laptop computer having a screen portion and a base portion, comprising:
a housing having a partially-enclosed cavity;
a flat panel display retractably and pivotally attached to said housing so that said flat panel display may be pivotally adjusted when extended from said cavity and in use and retracted to a position within said cavity when not in use;
means for electrically connecting said flat panel display to the laptop computer, said means being positioned within or on said housing;
at least one of an internal rechargeable power source for providing internal power to said flat panel display or a power jack for providing external power to said flat panel display, said at least one being positioned within or on said housing;
means for releasably joining said housing to the screen portion of the laptop computer; and
means for substantially supporting said auxiliary display system, wherein said means for supporting include means for releasably joining said housing to the base portion of the laptop computer.

14. An auxiliary display system according to claim 13, wherein said means for releasably joining is a bracket joined with a top edge or side edge of said housing.

15. An auxiliary display system according to claim 13, wherein said means for releasably joining is a suction cup joined with said housing.

16. An auxiliary display system according to claim 13, wherein said means for releasably joining includes an adhesive.

17. An auxiliary display system according to claim 13, wherein said means for substantially supporting said auxiliary display system are support legs pivotally joined with a bottom edge of said housing.

18. An auxiliary display system according to claim 13, wherein said means for releasably joining said housing to the base portion of the laptop computer include a clamp mechanism having a spring-loaded extendable clamp, a clamp tightening button operably joined with said clamp for tightening said clamp, and a release button operably joined with said clamp for loosening said clamp.

19. An auxiliary display system according to claim 17, wherein said means for releasably joining said housing to the base portion of the laptop computer include a pressure-fit mechanism for pressure fitting the base portion of the laptop computer between a first one of said support legs and a second one of said support legs.

20. An auxiliary display system for use with a laptop computer having a screen portion and a base portion, comprising:
a housing having a partially-enclosed cavity;
a flat panel display retractably and pivotally attached to said housing so that said flat panel display may be pivotally adjusted when extended from said cavity and in use and retracted to a position within said cavity when not in use;
at least one of a VGA input, a DVI input, a USB input, and a power jack for electrically connecting said flat panel display to the laptop computer, said at least one being positioned within or on said housing; and
support legs pivotally joined with a bottom edge of said housing for releasably joining said housing to the base portion of the laptop computer, wherein said support legs are configured to substantially support said auxiliary display system.
